(19) United States
(12) Patent Application Publication
(10) Pub. No.: US 2014/0038724 A1
(43) Pub. Date: Feb. 6, 2014

(54) ELECTRONIC GAME TOURNAMENT IN AN AMUSEMENT DEVICE NETWORK

(71) Applicant: Megatouch, LLC, Bristol, PA (US)

(72) Inventors: William L. LAYNE, IV, Harleysville, PA (US); Timothy Jason KOTZEN, Hatboro, PA (US); Vipul Harshard PATEL, Chalfont, PA (US)

(73) Assignee: Megatouch, LLC, Bristol, PA (US)

(21) Appl. No.: 13/957,143

(22) Filed: Aug. 1, 2013

Related U.S. Application Data
(60) Provisional application No. 61/678,344, filed on Aug. 1, 2012.

(51) Int. Cl. G07F 17/32

(52) U.S. Cl. CPC G07F 17/3276
USPC 463/42

(57) ABSTRACT

A method of operating a tournament in an amusement device network is described. A tournament is initiated with a plurality of electronic games playable by tournament participants using amusement devices participating in the tournament. Score information is received from amusement devices in the amusement device network. The score information is associated with tournament participants playing any of the plurality of electronic games. The received score information is normalized across the plurality of electronic games. A normalized tournament score is determined for each of the tournament participants and output to the amusement device network.

### CROSS-REFERENCE TO RELATED APPLICATIONS

This application claims priority to U.S. Provisional Patent Application 61/678,344, filed Aug. 1, 2012, entitled “Electronic Game Tournament in an Amusement Device Network,” the entire contents of which are incorporated by reference herein.

### BACKGROUND OF THE INVENTION

Embodiments of the present invention relate to electronic game tournaments, and in particular to multiplayer game tournaments on amusement devices connected to an amusement device network.

“Skill with Prize” (SWP) amusement devices are commonly found in public places (such as public houses, bars, cafes, restaurants, casinos, canteens, waiting rooms, or the like) and traditionally run a mix of “instant payout” games such as pub quizzes, simulated darts leagues, “Spot the Difference” challenges and so on. Players pay to play against a computer program executed by a processor within the amusement device in an attempt to win an instant prize (which might be cash) based on the player's ability to answer trivia questions or demonstrate manual dexterity, observation skills, or the like. The cash prize is paid out instantly by the amusement device to a winning player.

Another software application that currently runs on this type of gaming machine is “tournament play,” where instead of playing against a computer program, two or more players compete against each other in a high-score league format over a predetermined amount of time (e.g., one month, one week, or the like). The tournaments operate with a predetermined prize fund and prize award structure. Thus, such multiplayer tournaments offer players the opportunity to play against each other for increased prizes until the tournament ends.

Tournaments may be conducted in real time or may be turn-based, and may or may not be connected to an on-line network. Typically, a tournament includes a single type of game or challenge (e.g. Solitaire), where players' scores are placed on a “leader board.” Once the (time-based) tournament ends, all scores on the leader board are collated and the winner is paid out.

For SWP amusement devices which are not connected to an online network, an amusement device operator sets up a tournament event on a single offline amusement device so that only players in that location (e.g., a particular pub) may compete. Players visiting that location use the offline amusement device to play against one another on a score-matching system within a pre-determined timescale. Such tournaments are known as “local tournaments.”

When an operator sets up a local tournament on an amusement device he must input the start and end dates for each individual event and also often “seeds” the prize pool with an introductory amount (typically $8.00). Ongoing tournament games (typically at $1.60 per play) then further increment the potential prize pool at a rate that is configurable between 10 to 50% of the price of play. For example, if the operator “seeds” the prize pool with $8.00 and then sets the incremental rate at 20% and the price of play at $1.60, after no games (entries) have been played the prize pool will stand at $8.00; after one game it will be $8.30; after 10 games it will be $11.20 and so on through the fixed time duration of the individual tournament event.

All participating players must pre-register a chosen username and select a unique PIN (Personal Identification Number). Alternatively, players may participate by using their previously registered player accounts and/or player cards. When each tournament is complete, a final “league table” is displayed on the amusement device's screen and a prize winner is able to claim his prize by asking the manager (often the landlord) of the location to use his/her non-public PIN (or password) to access a claim screen where the player can input his player PIN number to prove that he is a bona fide winner. Once the identity of the winner has been verified via the claims process, the cash prize is paid to the winner by the personnel at the location (e.g., by the pub landlord from the till). However, there are numerous disadvantages associated with known local tournament systems. For example, local tournaments can only be set over a specified time period, and sometimes the local personnel do not want to be involved.

Another form of tournament experience is that of online (i.e., Internet-based) tournaments in which players use, via a website, an Internet-connected computer. To date, tournaments in the “physical” SWP terminal world have always been time-based. However, in the online sector, “high-score” tournaments based on a fixed number of games (entries) are offered via web sites. Such tournament events are designed to conclude when a pre-determined number (e.g., 2, 4, 8, 16, 32, 64, or the like) of individual games has been played. Such online/internes events and games all operate on the basis of player accounts. Prior to competing, each player must create a funding account from which entries are paid and/or into which prizes are fulfilled. Prizes are fulfilled using these accounts or by electronic transfer (using PayPal or the like) or even by posting checks in the mail.

### BRIEF SUMMARY OF THE INVENTION

Briefly stated, a preferred method of operating a tournament in an amusement device network is described. A tournament is initiated with a plurality of electronic games playable by tournament participants using amusement devices in the amusement device network and participating in the tournament. Score information is received from amusement devices in the amusement device network participating in the tournament. The score information is associated with tournament participants playing any of the plurality of electronic games. The received score information is normalized across the plurality of electronic games. A normalized tournament score is determined for each of the tournament participants and output to at least one amusement device in the amusement device network.

In another aspect, a preferred method of initiating a tournament in an amusement device network is described. A request to initiate the tournament is received from an administrator. The request defines a tournament period between a start time and an end time. Selections of a plurality of electronic games included in the tournament are received. The tournament is conducted with the selected plurality of electronic games being playable on amusement devices in the amusement device network during the tournament period. Results of tournament participants are normalized for the plurality of electronic games included in the tournament. A leader board of the tournament participants is populated based on the normalized scores. Positions of the tournament participants on the leader board are determined independently of the individual games played by the tournament participants.

In another aspect, a preferred method of operating a tournament in an amusement device network is described. A plurality of challenges are defined in a plurality of electronic games. The electronic games are playable on currency operated amusement devices in the amusement device network. Point values are assigned for completing each of the challenges in each of the plurality of electronic games. The tournament is conducted with a plurality of tournament participants playing at least one of the plurality of electronic games on a currency operated amusement device in the amusement device network. A tournament leader board is populated based on a total point score of each of the tournament participants. The total point score is based on the challenges completed by each of the tournament participants.

In another aspect, a preferred method of operating a multiplayer tournament in an amusement device network is described. The multiplayer tournament is initiated with at least one electronic game playable by multiple users simultaneously on one or more currency operated amusement devices in the amusement device network. Combined scores for each of a plurality of game play instances of the at least one electronic game are received. Each of the combined scores correspond to a game play score of a team of tournament participants for the respective game play instance. Team scores are calculated for each of the teams of tournament participants based on the received combined scores. A tournament leader board is populated based on the calculated team scores.

In another aspect, a preferred method of conducting a bracket elimination tournament in an amusement device network is described. A tournament is initiated including at least one electronic game playable by a plurality of tournament participants on one or more currency operated amusement devices. A plurality of tournament participants are registered. The tournament participants play the at least one electronic game on the one or more currency operated amusement devices. Each of the registered tournament participants is assigned to a slot in an elimination bracket. Each slot is assigned a predefined opponent slot in the bracket. A winning player of the opposing slots advances to a further round of the bracket elimination tournament. Game play of the at least one electronic game is managed such that tournament participants are eliminated until a single tournament participant remains.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood. however, that the invention is not limited to the precise arrangements and instrumentalities shown. In the drawings:

FIG. 1A is a front perspective view of an amusement device in accordance with a first preferred embodiment of the present invention;

FIG. 1B is a front perspective view of an amusement device in accordance with a second preferred embodiment of the present invention;

FIG. 1C is a front perspective view of an amusement device in accordance with a third preferred embodiment of the present invention;

FIG. 2 is a flowchart illustrating steps for conducting a challenge-based tournament according to an embodiment of the present invention;

FIG. 3 is a flowchart illustrating steps for conducting a team tournament according to another embodiment of the present invention;

FIG. 4 is a flowchart illustrating steps for conducting a bracket tournament according to another embodiment of the present invention;

FIG. 5 is a flowchart illustrating steps for conducting a multi-game tournament according to another embodiment of the present invention; and

FIG. 6 is a sequence diagram for initiating and operating a tournament through a tournament server.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and instruments and related parts thereof. The terminology includes the above-listed words, derivatives thereof and words of similar import.

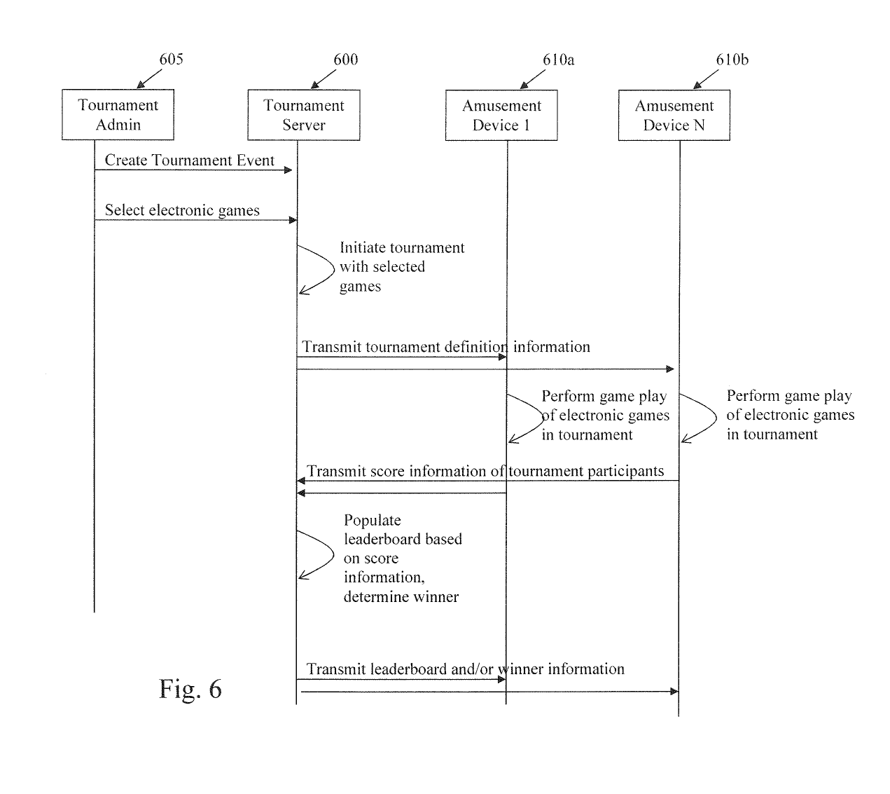

In accordance with embodiments of the present invention, there is provided an amusement device network comprising a plurality of currency operated amusement devices. The currency operated amusement devices may be in communication with one or more local or remote servers (FIG. 6) for initiating and managing tournaments. In one embodiment, the one or more servers may be used to define a plurality of different tournament types playable by tournament participants on the plurality of currency operated amusement devices.

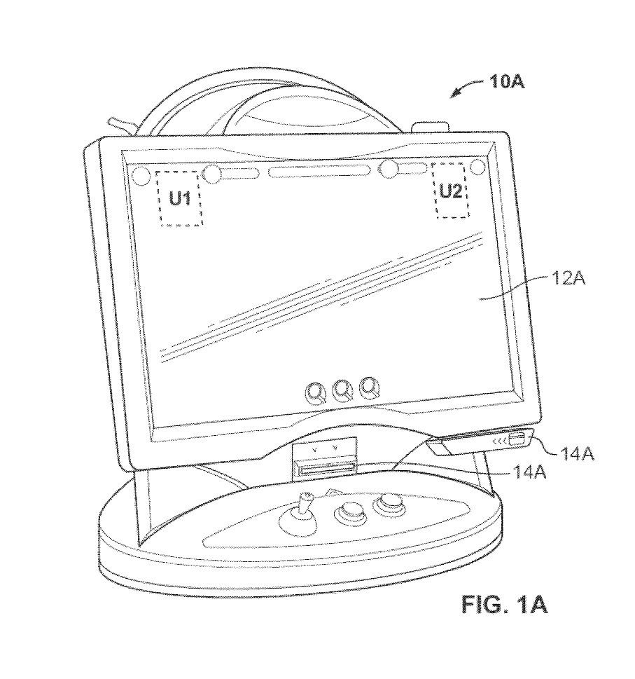

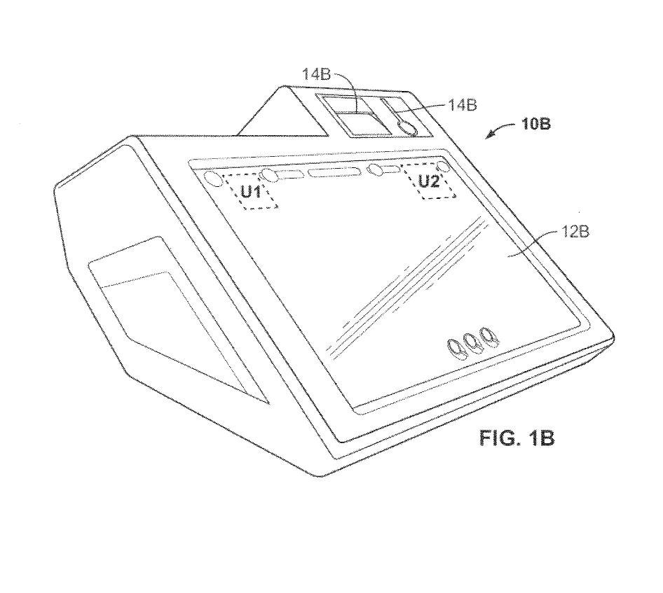

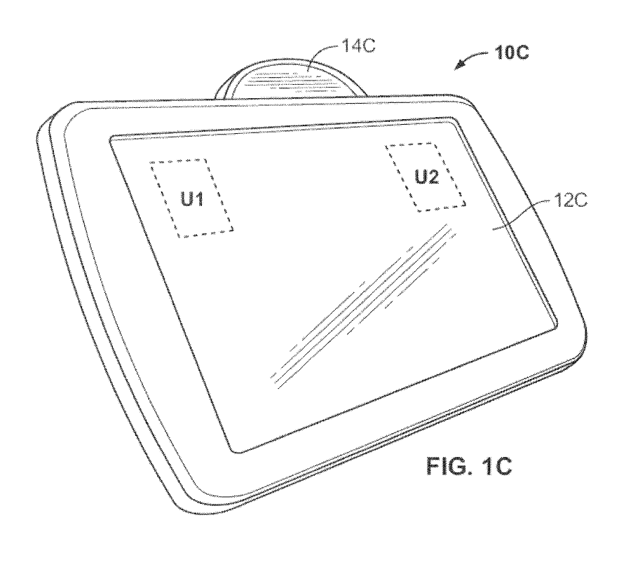

Referring to the drawings in detail, wherein like reference numerals indicate like elements throughout, there is shown in FIG. 1A a first preferred embodiment of an amusement device 10A. The amusement device 10A includes a controller U1 and a memory U2. The memory U2 can be any known or suitable memory device such as random access memory (RAM), read only memory (ROM), flash RAM, hard disk, optical disk, or the like. The amusement device 10A further includes a video display 12A that is operatively connected to the controller U1. The amusement device 10A is preferably a counter-top or table-top apparatus, but may be arranged in any configuration, such as free-standing, floor-standing, table mounted, wall mounted, pole mounted, and the like without departing from the invention.

The amusement device 10A also includes at least one input component 14A that receives value in order to establish one or more playable credits. The value received may be at least one of currency, coins, tokens, chits, credits, credit cards/debit cards or the like. Although two input components 14A are shown, the amusement device 10A may include any number of input components 14A to give a user an option for payment, for permitting multiple players, or the like. Preferably, the amusement device 10A is made operable upon actuation of the input component 14A. For example, a user may only select and play an electronic game once value is received at the input component 14A and/or one or more playable credits are issued to the user. However, free selections may be offered at the discretion of an operator of the amusement device 10A.

FIG. 1B shows another or second amusement device 10B in accordance with a second preferred embodiment of the present invention. The second amusement device 10B also includes a controller U1, a memory U2, a display 12B, and at least one input component 14B. Preferably, the video displays 12A, 12B are touchscreen video displays configured to accept touch input.

FIG. 1C shows yet another or third amusement device 10C in accordance with a third preferred embodiment of the present invention. The third amusement device 10C is a portable device, preferably battery-powered, and includes a controller U1, memory U2, a display 12C, and at least one input component 14C. The third amusement device 10C is preferably usable with a docking station (not shown). The docking station preferably secures the device 10C until accessed by an operator or paid for by a user. Release from the docking station may occur via an entry through the input component 14C, which is preferably a card reader. The docking station may also provide battery recharging and other services to the amusement device 10C.

For convenience, the amusement devices 10A, 10B, 10C will be referred to hereinafter simply as “amusement device 10,” the displays 12A, 12B, 12C will be referred to hereinafter simply as “display 12,” and the input components 14A, 14B, 14C will be referred to hereinafter simply as “input component 14.”

Turning now to the operation of the amusement device 10, the memory U2 stores one or more application programs, such as electronic games, a music or video jukebox program, or the like, and a system control program. However, the one or more application programs may also be stored remotely. The controller U1 controls the touchscreen display 12 based upon the system control program retrieved from the memory U2 and based upon inputs from the touchscreen display 12. As used herein, the system control program refers to all of the software functions outside of the application program files including an operating system, device profile, display control, input control, sound drivers, and the like. A device profile is a set of definitions or parameters that control the operation, functions and/or settings of the amusement device 10 as described further herein. Though the device profile is described as being stored in memory U2 of amusement device 10, it should be understood that the device profile may also be stored remotely. Other input devices which may be connected to the amusement device 10 include a pushbutton(s), a trackball or touchpad, a mouse, a joy-stick, a foot-pedal, a voice recognition system, a keypad or keyboard, and the like. But, preferably, the input device is the touchscreen display 12. Users interact with the amusement device 10 to play electronic games against the computer or against other users.

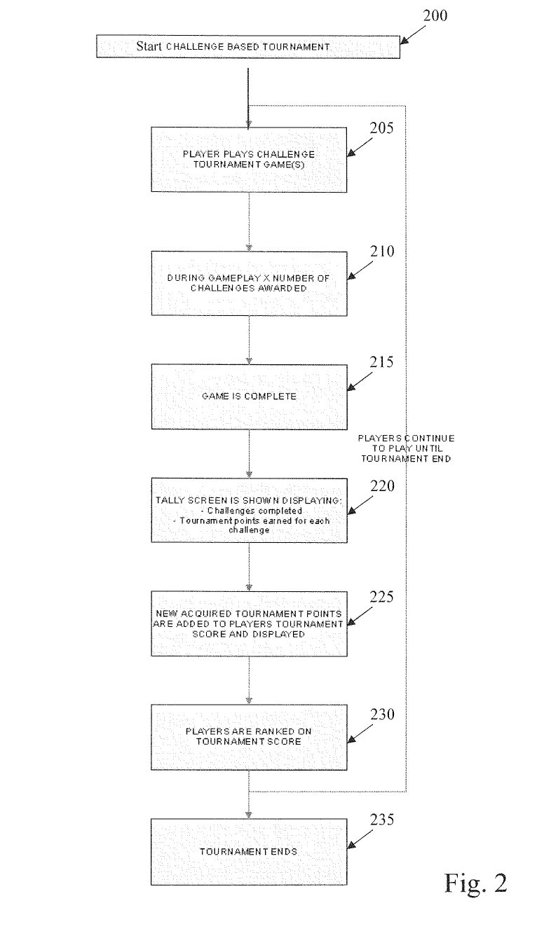

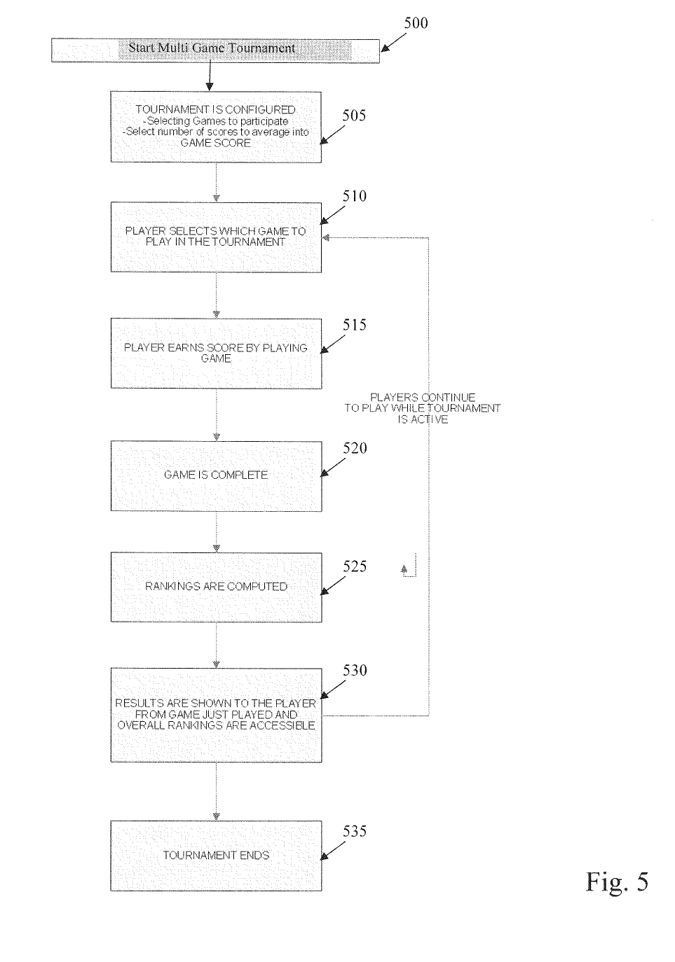

Tournaments that include one or more such electronic games may be initiated for example, by selecting a tournament type, defining a tournament start time and end time (if necessary), and selecting one or more electronic games that are included in the tournament (if necessary). Players participate in the defined tournament by interacting (e.g., playing electronic games) with the amusement devices 10. Each of the tournament types will now be described with reference to FIGS. 2-5.

### Challenge-Based Tournament

In a challenge-based tournament, tournament participants compete with one another to complete pre-defined challenges that are defined within the electronic games. The outcome of the tournament is determined based on the number and type of challenges completed by tournament participants. Challenges may preferably be completed in each of the electronic games included in the tournament. While a challenge-based tournament may include a single electronic game, preferably a plurality of electronic games are included in the challenge-based tournament. As discussed further below, one or more challenges that may be completed within each of the electronic games included in the challenge-based tournament are defined. Preferably, a point value is assigned to each of the defined challenges. When a player completes a challenge, the assigned point value is attributed to the player's total score for the tournament. In an alternate embodiment, each challenge may be given an equal weight, thus allowing participants to compete based on the total number of challenges completed.

Challenges in the electronic games may be defined by the game developer, by the amusement system operator, the tournament operator, the venue operator, or any other entity that is authorized to create, define, or modify challenges within an electronic game. Preferably, a plurality of default challenges are defined for each of the electronic games. Additional challenges may defined to provide additional entertainment and opportunities for tournament participants to improve their scores. Preferably, all of the challenges in an electronic game are available for each tournament. However, in another embodiment, a tournament operator may select a subset of the available challenges to be available in a particular tournament.

The challenges available in any given tournament and/or electronic game may be known to a player, such as where a list of the available challenges for an electronic game is displayed on the amusement device executing the electronic game prior to the electronic game being initiated. Alternatively, the challenges may initially be hidden until the player completes the challenge. Preferably, the challenges are designed so that they appeal to a broad range of player interests, and may be achieved by players of different skill levels. Thus, a player who is not the best overall player in a particular electronic game may still be able to do well in a challenge-based tournament by completing challenges based on the skill of the player. However, it is important that the challenges in each electronic game not be so easy as to allow a novice player with limited skills to “buy” a tournament by playing significantly more than a more advanced player.

Some examples of challenges in an electronic game include completing a round under a certain time limit, scoring a predetermined number of points in a single round, eliminating every enemy in a round, eliminating all enemies in every round, completing a predetermined combination of actions, and the like.

Preferably, a player earns the points assigned to a challenge each time the player completes the challenge. Thus, players with developing skills are encouraged to play frequently in the tournament, thereby compiling a higher score by repetitively completing attainable challenges. Such players are rewarded by being able to compete with more skilled players in the tournament. However, in another embodiment, a player may only receive the points assigned to a challenge the first time the player completes the challenge and future completions of the same challenge do not add any points to the player's score.

Referring to FIG. 2, a flowchart illustrating steps for conducting a challenge-based tournament is shown. The challenge based tournament begins at step 200 and proceeds to step 205, where a player begins playing one or more electronic games that are included in the challenge based tournament. At step 210, as the player plays the one or more electronic games, the player is awarded for completing challenges. The total number of challenges completed is tracked. Further, if necessary, the corresponding values of the completed challenges are totaled and tracked. At step 215, game play of the one or more electronic games is completed.

At step 220, a tally screen is shown. The tally screen displays the challenges completed by the player. Additionally, tournament points earned for each of the completed challenges may be displayed. At step 225, the newly acquired tournament points from the completed one or more electronic games are added to the player's tournament score. The tournament score for the player is displayed to the player, and optionally, to other venue patrons. For example, the player's score may be displayed on a television or other electronic device deployed at the venue where the player participated in the tournament. At step 230, players participating in the challenge-based tournament are ranked based on their achieved tournament scores. Additional players may participate in the challenge-based tournament by returning to the start step 200. Multiple players may participate in the challenge-based tournament sequentially or simultaneously (on the same or other amusement devices 10) with one another. A leader board may be populated based on the rankings, and a winner may optionally be selected. The tournament ends at step 235 and the prize(S) is awarded.

### Team Tournament

In a team tournament, teams (e.g., two or more players) of tournament participants compete together to attain a combined score for the tournament. Thus, teammates must work together during the tournament in order to successfully compete in a team tournament. Preferably, team tournaments are based on teams having two participants per team, but there is no limit on the number of teams allowed in a tournament. In other embodiments, teams may have more than two team members per team. Similarly, a limit may be placed on the number of teams that may register. For example, team tournaments may be limited to 20, 50 or 100 teams. However, any other number of teams may be set as a team limit.

Team tournaments are initiated by a tournament organizer preferably defining a start time, an end time, and one or more electronic games that are included in the team tournament. Additional tournament options, such as team size, total number of teams, and scoring system may also be set by the organizer. Only games capable of being played in a multiplayer mode, or with multiple players, may be included in a team tournament. Thus, games having a head-to-head battle mode and collaborative games, such as a spot the difference game, are optimal for a team tournament.

After a team tournament has been defined, tournament information is made available to the amusement devices 10 participating in the team tournament. For example, where the team tournament is a local tournament, the amusement devices at a single venue may participate in the defined team tournament. In other embodiments, a tournament may include participants using amusement devices 10 deployed at distinct venues.

Players register with the tournament by signing into their respective player accounts. In order to sign into a player account, the player provides a user name and password, or other identifying token, such as a player card. Once signed in, the player may view tournament information, and select a teammate to participate in the team tournament with.

In a preferred embodiment, a listing of users registered for the team tournament is displayed, along with other information such as an avatar, favorite electronic games, and skill level. The user may also select a preferred player as a teammate by entering a real name or user name of that player in a user name dialog box. The preferred player may have previously registered with the tournament, or may be unregistered. The preferred player logs in with an assigned player account to accept the team invitation. In one embodiment, individual players can be team members in as many teams as they would like. However, limits on the number of teams an individual player can join may be established without departing from the scope of this invention.

Once teams are registered, teammates of each team work together to achieve a combined high score as a team. Thus, win/loss statistics of individual team members are de-emphasized in favor of cooperation in trying to earn the best possible combined score for the team. Preferably, each game has multiple rounds (e.g., three rounds or five rounds extended play). At the end of a multi-round game, the team's scores from each round are combined into a team score for that game.

Preferably, each team plays a predetermined number of games before becoming eligible for a tournament ranking. Once the predetermined number of games have been played by a team, the team scores for each of the played games are averaged, summed, or otherwise aggregated, to determine a tournament score for the team. Tournament rankings of the teams are determined based on the respective tournament scores of the teams. In an alternate embodiment, a subset of all available team scores are aggregated to determine a tournament score. For example, a tournament organizer may decide to average only the top five team scores for each team in determining a tournament score for the team.

Team scores are presented in a tournament leader board. In a preferred embodiment, a team name is displayed as a combination of each team member's user names. In another embodiment, teams may choose a unique team name to represent the team. Regardless the team name format, a tournament score for the team is displayed together with the team name.

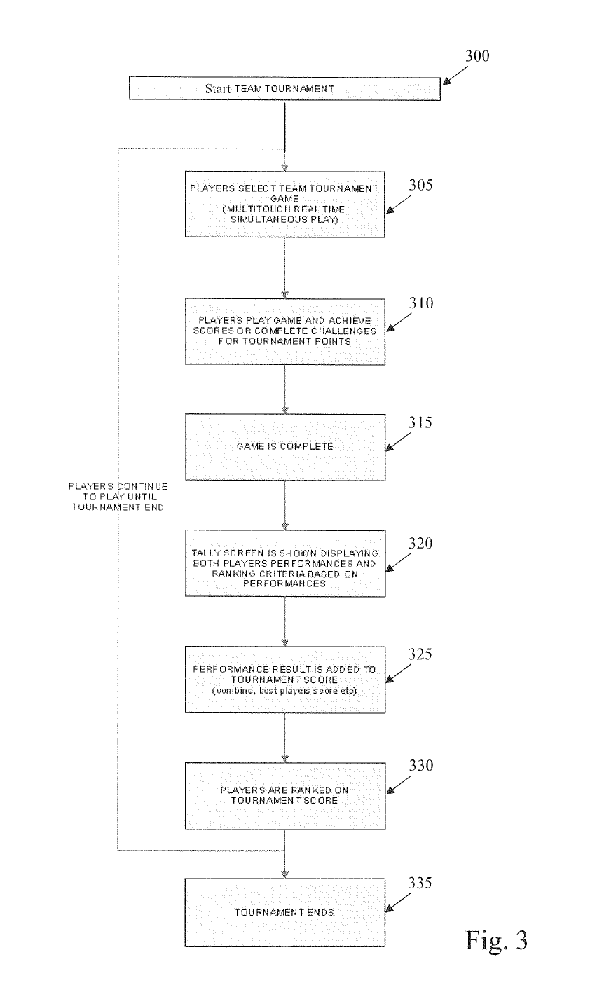

Referring to FIG. 3, a flowchart illustrating steps for conducting a team tournament having a plurality of registered teams is shown. The team tournament begins at step 300 and proceeds to step 305, where tournament participants select one or more electronic games. Preferably, the players select from games that have been made available for the team tournament, such as multitouch real time simultaneously playable games. At step 310, players play the selected one or more electronic game and achieve scores, or complete challenges for tournament points. Thus, the team tournament of FIG. 3 may be combined with the challenge-based tournament of FIG. 2, wherein teams attempt to complete the most number of in-game challenges as a team. The players complete playing the selected one or more electronic games at step 315.

After completion of game play, a tally screen is shown at step 320. The tally screen displays information about the performance of the teammates. Ranking criteria for the performance is similarly displayed. In one embodiment, the tally screen is only displayed to the teammates. In other embodiments, the tally screen or the performance information may be displayed to other team tournament participants and/or venue patrons. At step 325, the performance result for the played game is added to the team's tournament score, and the teams are ranked based on the tournament scores of the teams at step 330. The next team plays one or more electronic games by returning to step 300. It should be noted that while participation in the tournament may be sequential, with teams taking turns playing the electronic games, the tournament may also be held with multiple teams playing the electronic games simultaneously. After all teams have completed the tournament, the team tournament ends at step 335.

### Bracket Tournament

In a bracket-based tournament, a pool of tournament participants competes against each other through a series of eliminations to determine a winner of the tournament. A bracket-based tournament includes a plurality of rounds matching up participants in head-to-head contests. Preferably, the bracket-based tournament is specific to participants at a single geographic location (e.g., a bar or pub). In another embodiment, the bracket-based tournament may include multiple locations.

The bracket-based tournament may be conducted on a single amusement device 10 at a single location, or it may be conducted on multiple amusement devices 10, with each round of the tournament taking place substantially simultaneously (e.g., on the same day or same weekend). For example, eight, sixteen or thirty-two amusement devices 10 may be used for a single bracket tournament, depending on the number of tournament participants. Each round of a bracket-based tournament is preferably completed before the next round begins.

Preferably, the tournament is limited to having 2ⁿ players so that each player has an opponent in each round of the tournament. Thus, a typical tournament will include 4, 8 or 16 participants. However, non-even numbers of players are possible, with certain participants receiving a “bye” in one or more rounds of the bracket-based tournament. Larger tournaments may also be created by a tournament operator to include additional venues. For example, a 64 participant NCAA-style bracket-based tournament having four distinct divisions may be initiated. In such a tournament, each of the divisions may be assigned to a dedicated amusement device 10 or a distinct venue at which that portion of the tournament will be played.

The bracket-based tournament may be organized by an amusement device manufacturer, operator, or developer. Alternatively, venue specific tournaments may be organized by venue staff and/or management. Tournaments are created at a management console that is preferably accessible over the Internet. In a preferred embodiment, the tournament organizer provides a start time for the tournament and selects one or more electronic games playable in the tournament.

Preferably, the bracket-based tournament is a single elimination tournament. In a single elimination tournament, opponents play one another in one or more electronic games and the winner moves on to the next round, while the loser is eliminated. However, a loser bracket may also be provided to allow losing players to further partake in the tournament after being eliminated from the main bracket.

Electronic games that are available for a bracket-based tournament are head-to-head games, such as spot the difference games, word games, and the like that may be played by multiple players simultaneously (e.g., in a real-time head-to-head or battle mode). Preferably, each electronic game includes multiple rounds. Opposing players that are matched against each other in the bracket play the selected multiplayer electronic game against each other until a winner is determined. While a tournament may be limited to a single electronic game played by all tournament participants, multiple electronic game options may also be included. Where multiple electronic game options are available, each pair of opponents may decide on one of the electronic games to play. Alternatively, an electronic game may be assigned to the match-up either randomly or by a tournament operator.

Preferably, the amusement device 10 executing the bracket-based tournament or one or more electronic devices associated with the amusement device 10 display a bracket showing an up-to-date the status of the tournament. Preferably, the players are initially seeded in the bracket based on past performance, ranking, or self selected skill levels. In another embodiment, the players may be randomly seeded. In one embodiment, the tournament bracket is arranged such that the strongest participant plays the weakest participant, the next strongest plays the next weakest, and so on. As games of the tournament are played, the bracket is updated showing winners and losers, and upcoming matchups. Once a round of the tournament has been completed, the next round may begin, with winners from the previous round facing each other according to their seeds. When all rounds of the tournament are completed, a tournament winner, and optionally, a runner up, is shown. In one embodiment, the tournament winner may receive a prize. The prize, for example, playable credits, may be assigned by a tournament organizer or the location management and/or staff.

Preferably, prior to the start of a bracket-based tournament, users are given an opportunity to register with the tournament. Users register by logging into their player account. After logging in, the user selects a tournaments screen to bring up a tournament selection GUI, where the user is able to select a desired tournament from a list of available tournaments. Preferably, the list of available tournaments is sorted and/or filtered based on tournament location so that tournaments closest to the player are shown first. The location of the player may be determined, for example, based on the identification of the amusement device 10 into which the player's user account is logged in. In other embodiments, a player may join a tournament by accepting an invitation to participate in the tournament.

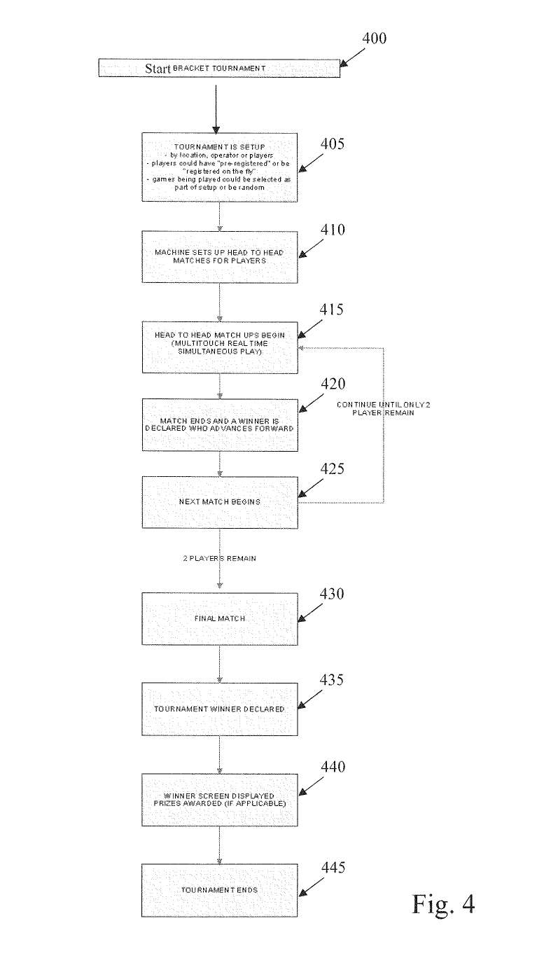

Referring to FIG. 4, a flowchart illustrating steps for conducting a bracket tournament having a plurality of registered participants is shown. The bracket tournament starts at step 400 and proceeds to step 405. The tournament is set up at step 405 by the location manager or staff, tournament operator or tournament participants. Players may be pre-registered to participate in the tournament, or may be registered as part of the tournament setup step 405. Similarly, electronic games to be played in the bracket tournament may be selected during tournament setup step 405 or may be randomly selected. Once the tournament has been setup, and all participants have been registered, the amusement device 10 determines head to head matches for the participants at step 410.

The bracket tournament proceeds with game play in steps 420-430. At step 420, the head to head match ups between participants begin. At step 425, a match ends and a winner is decided. The winner advances to the next round. At step 430, the next match begins and a head to head match up is played at step 420. The process of steps 420-430 continues until two players remain in the bracket tournament. A final match between the two final players is played at step 435. A tournament winner is declared at step 440 based on the results of the match played at step 435. A winner screen is displayed and if applicable, prizes are awarded at step 445. The bracket tournament ends at step 450.

### Multi Game Tournaments

In a multi game tournament tournament, each tournament participant must play a plurality of distinct electronic games to achieve a tournament score. Preferably, the number of electric games to be played by each participant is between 2 and 5 games. Tournament scores are determined based on a player's score in each of the games played. Thus, in one embodiment, the top scores for each of the games included in the tournament are averaged to determine a total game score for the player. In other embodiments, a predetermined number of top scores for each game are averaged to determine the player's total game score.

Tournament rankings are determined based on the total scores of the participants. In one embodiment, the rankings are based on a total score achieved by each of the participants in each of the games played. In another embodiment, the rankings are based on an average of the game scores. The average may be a weighted average, wherein individual games are weighted based on game length, difficulty, or the like. Based on the total game score of the participants, a tournament leader board is populated. While the total game scores of the participants may be displayed, in a preferred embodiment the total game scores are normalized to make the multi game tournament results fair for all participants regardless of the games played by those participants. While the overall tournament leaders are determined based on the total game score, results for one or more of the individual electronic games may also be displayed.

FIG. 6 is an illustration of steps for conducting a multi-game tournament. The process begins at step 500 and proceeds to step 505, where the tournament is configured. During the tournament configuration step 505, participating games are selected for the tournament. Scoring information, such as the number of scores to be averaged into the game score, is also defined. Once the tournament is configured, tournament participants may begin playing games.

At step 510, a tournament participant selects which game to play in the tournament. At step 515, the tournament participant plays the game selected in step 510 to earn a score for the selected game. The game is completed at step 520, and rankings for the tournament are updated at step 525 with the score information from the game completed at step 520. Results are shown the player from the game just played at step 530. Overall rankings for the tournament may also be shown at step 530. Steps 510-530 are repeated for each of the tournament participants. In one embodiment, each player plays multiple games of the tournament at various times during the tournament. Thus, steps 510-530 may be repeated for each game played by a single participant. For example, if the tournament requires each participant to play four (4) games, the steps 510-520 will be repeated four (4) times for each tournament participant. In another embodiment, each tournament participant selects multiple games to be played at step 510 and plays each of the selected games at step 515. Thus, the tournament participant completes all games necessary to receive a tournament game score at step 520. Once all tournament participants have played the necessary number of games, the tournament ends at step 535 with a tournament winner being determined, and if applicable, prizes being awarded.

In one embodiment, tournament scoring and setup for each of the tournaments described herein may be performed at the amusement device 10 on which the tournament is conducted. In another embodiment, referring to FIG. 6, a tournament server 600 manages tournament setup and scoring. A tournament administrator 605 (e.g., venue management or staff, a tournament participant, game developer or publisher) creates a tournament event by interacting with the tournament server 600. Preferably, the tournament server 600 provides a graphical user interface for setting up a tournament. The tournament administrator 605 may interact with the tournament server 600, for example, through another computing device or an amusement device 10. In creating the tournament event, the tournament administrator 605 selects one of the tournament types (e.g., challenge tournament, team tournament, bracket tournament, multi game tournament) and selects one or more electronic games to be included in the tournament. The tournament server 600 then initiates the tournament with the selected games. The tournament server 600 transits tournament definition information to amusement devices 1-N 610a, 610b that are participating in the initiated tournament. Players participate in the initiated tournament by playing electronic games on the amusement devices 1-N 610a, 610b. Once the electronic games have been played, the amusement devices 1-N 610a, 610b transmit score information of the tournament participants to the tournament server 600. The tournament server 600 receives the scores, populates a leader board based on the score information, and if applicable, determines a tournament winner. The leader board and winner information is optionally made available to the amusement devices 1-N 610a, 610b.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A method of operating a tournament in an amusement device network, the method comprising:
initiating a tournament including a plurality of electronic games playable by tournament participants using amusement devices in the amusement device network and participating in the tournament;
receiving score information from amusement devices in the amusement device network participating in the tournament, the score information associated with tournament participants playing any of the plurality of electronic games;
normalizing the received score information across the plurality of electronic games;
determining a normalized tournament score for each of the tournament participants; and
outputting to at least one amusement device in the amusement device network the normalized tournament score.

2. The method of claim 1, wherein the plurality of electronic games is a subset of all games available on the amusement device.

3. The method of claim 1, wherein normalizing the received score information further comprises increasing a score received by a tournament participant by a predetermined amount.

4. A method of initiating a tournament in an amusement device network, the method comprising:
receiving a request to initiate the tournament from an administrator, the request defining a tournament period between a start time and an end time;
receiving selections of a plurality of electronic games included in the tournament;
conducting the tournament with the selected plurality of electronic games being playable during the tournament period on amusement devices in the amusement device network;
normalizing results of tournament participants for the plurality of electronic games included in the tournament; and
populating a leader board of the tournament participants based on the normalized scores, wherein positions of the tournament participants on the leader board are determined independently of the individual games played by the tournament participants.

5. A method of operating a tournament in an amusement device network, the method comprising:
defining a plurality of challenges in a plurality of electronic games, the electronic games being playable on currency operated amusement devices in the amusement device network;
assigning a point value for completing each of the challenges in each of the plurality of electronic games;
conducting a tournament, the tournament including a plurality of tournament participants playing at least one of the plurality of electronic games on an amusement device in the amusement device network; and
populating a tournament leader board based on a total point score of each of the tournament participants, wherein the total point score is based on the challenges completed by each of the tournament participants.

6. The method of claim 5, wherein the point values for each of the challenges are assigned based on the relative difficulty of completing the respective challenges.

7. The method of claim 5, wherein a tournament participant is awarded a point value assigned to a challenge each time the tournament participant completes that challenge during the tournament.

8. The method of claim 5, wherein the total point score is independent of player scores awarded to tournament participants for completing game play of the electronic Games.

9. A method of operating a multiplayer tournament in an amusement device network, the method comprising:
initiating the multiplayer tournament, the multiplayer tournament including at least one electronic game playable by multiple users simultaneously on one or more currency operated amusement devices in the amusement device network;
receiving combined scores for each of a plurality of game play instances of the at least one electronic game, each of the combined scores corresponding to a game play score of a team of tournament participants for the respective game play instance;
calculating team scores for each of the teams of tournament participants based on the received combined scores; and
populating a tournament leader board based on the calculated team scores.

10. The method of claim 9, wherein the at least one electronic game is played collaboratively by the multiple tournament participants.

11. The method of claim 9, wherein the at least one electronic game is played in a versus mode by the multiple tournament participants.

12. A method of conducting a bracket elimination tournament in an amusement device network, the method comprising:
initiating a tournament, the tournament including at least one electronic game playable by a plurality of tournament participants on one or more currency operated amusement devices;
registering a plurality of tournament participants, the tournament participants playing the at least one electronic game on the one or more currency operated amusement devices;
assigning each of the registered tournament participants to a slot in an elimination bracket, wherein each slot is assigned a predefined opponent slot in the bracket, and wherein a winning player of the opposing slots advances to a further round of the bracket elimination tournament; and
managing game play of the at least one electronic game such that tournament participants are eliminated until a single tournament participant remains.

13. The method of claim 12, wherein the registered tournament participants are assigned to one of the slots in the elimination bracket based on a skill level of the respective tournament participants.

14. The method of claim 13, wherein the registered tournament participants are provided a seed, and wherein in a first round of the tournament, tournament participants with the highest seeds are assigned to play against tournament participants with the lowest seeds.
